(19) United States
(12) Patent Application Publication
(10) Pub. No.: US 2017/0090063 A1
(43) Pub. Date: Mar. 30, 2017

(54) Methods and Systems for Permanent Gravitational Field Sensor Arrays

(71) Applicant: HALLIBURTON ENERGY SERVICES, INC., Houston, TX (US)

(72) Inventors: Luis E. San Martin, Houston, TX (US); Etienne M. Samson, Cypress, TX (US); Satyan G. Bhongale, Cypress, TX (US)

(73) Assignee: HALLIBURTON ENERGY SERVICES, INC., Houston, TX (US)

(21) Appl. No.: 15/311,708

(22) PCT Filed: Jun. 25, 2014
(86) PCT No.: PCT/US2014/044140

§ 371 Date: Nov. 16, 2016

(51) Int. Cl. G01V 7/06

(52) U.S. Cl. CPC G01V 7/06

(57) ABSTRACT

A gravitational logging method includes obtaining gravitational field measurements from a permanent array of downhole or subsea sensor units. The method also includes inverting the gravitational field measurements as a function of position to determine a reservoir property. A related system includes a permanent array of downhole or subsea sensor units to obtain gravitational field measurements. The system also includes a processing unit that inverts the gravitational field measurements as a function of position to determine a reservoir property.

### BACKGROUND

During oil and gas exploration and production, many types of information are collected and analyzed. The information is used to determine the quantity and quality of hydrocarbons in a reservoir, and to develop or modify strategies for hydrocarbon production. Gravitational field monitoring is among the types of information proposed for collection, however, existing gravitometers for downhole sensing appear to have persistent issues with accuracy and long-term sensor drift.

### BRIEF DESCRIPTION OF THE DRAWINGS

Accordingly, there are disclosed herein methods and systems for permanent gravitational field sensor arrays. In the drawings:

FIGS. 1A-1D show illustrative gravitational field survey environments.

FIG. 2 shows illustrative permanent gravitational field sensor arrays.

FIGS. 3A-3I show illustrative gravitational field sensor configurations.

FIG. 4 shows an optical frequency multiplexing process.

FIG. 5 shows an array of sensor units in a unidirectional configuration.

FIG. 6 shows an array of sensor units in a bidirectional configuration.

FIG. 7 shows a flowchart of an illustrative gravitational logging control process.

FIG. 8 shows a flowchart of an illustrative gravitational log inversion process.

FIG. 9 shows a flowchart of an illustrative gravitational logging method.

It should be understood, however, that the specific embodiments given in the drawings and detailed description below do not limit the disclosure. On the contrary, they provide the foundation for one of ordinary skill to discern the alternative forms, equivalents, and other modifications that are encompassed in the scope of the appended claims.

### DETAILED DESCRIPTION

Disclosed embodiments are directed to methods and systems for a permanent downhole or subsea gravitational field sensor array. As used herein, “permanent” refers to a period of time suitable for downhole or subsea monitoring operations. While such monitoring operations are intended to occur over a period of weeks, months, or years, shorter monitoring intervals are possible. Further, “permanent” may also refer to a condition that is difficult to reverse. Thus, a gravitational sensor array deployed for a monitoring interval using a tubing string or subsea umbilical is an example of a permanent gravitational sensor array even though the tubing string is easy to retrieve. Further, a gravitational sensor array that is bonded to or otherwise secured to casing of a well installation is an example of a permanent gravitational sensor array due to the difficulty of reversing the deployment, especially if the gravitational sensor array is cemented in place.

In an example method, gravitational field measurements are obtained from a permanent array of downhole or subsea sensor units. The gravitational field measurements are inverted as a function of position (e.g., a three-dimensional coordinate position) to determine a reservoir property. The position information used for the inversion can be determined, for example, by correlating with openhole logs. Further, in some embodiments, the position of a gravitational field sensor unit can be determined if the position of another sensor (e.g., another gravitational field sensor or possibly another type of sensor) is known or determinable (e.g., the offset between the gravitational field sensor and the other is known). Once the position of one gravitational field sensor unit has been determined, the position of other gravitational field sensor units with known offsets from each other can be determined. The degree of inaccuracy in the position of the gravitational field sensor units will transfer to a degree of inaccuracy in the results of the inversion. Further, in some embodiments, one or more tools can be deployed in a borehole to determine the position of sensor units by emitting a source signal and by analyzing a response signal from the sensor units. In such case, the position of the tool is known, and the position of the sensor units are deduced from the response signals. In a subsea scenario, GPS and low frequency electromagnetic (EM) signals can be used to determine the position of sensors units.

In at least some embodiments, the gravitational field sensor array employs fiber optic monitoring or interrogation, where the monitoring/interrogation interface is located at earth's surface. With fiber optic monitoring or interrogation, the number of downhole or subsea electronic components is reduced, resulting in increased reliability and lower cost compared to an electrical monitoring or interrogation.

The sensor units of a permanent array are deployed, for example, in a downhole environment as part of one or more permanent well installations. Example permanent well installations include production wells, injections wells, and monitoring wells. Various permanent gravitational field array options, sensor options, and related monitoring methods and systems are described herein.

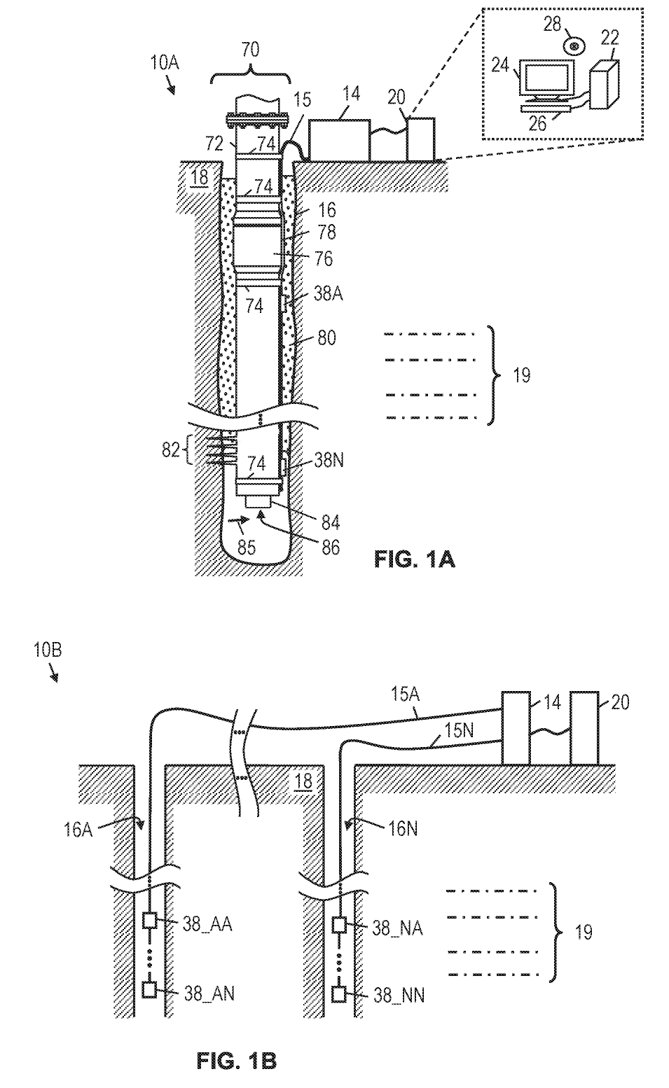

FIGS. 1A-1D show illustrative gravitational field survey environments including single well, multi-well, and subsea survey environments. FIG. 1A shows a permanent well survey environment 10A, where well 70 is equipped with one or more sensor units 38-A-38N for obtaining gravitational field measurements. In the permanent well survey environment 10A, a drilling rig has been used to drill borehole 16 that penetrates formations 19 of the earth 18 in a typical manner. Further, a casing string 72 is positioned in the borehole 16. The casing string 72 of well 70 includes multiple tubular casing sections (usually about 30 feet long) connected end-to-end by couplings 76. It should be noted that FIG. 1A is not to scale, and that casing string 72 typically includes many such couplings 76. Further, the well 70 includes cement slurry 80 that has been injected into the annular space between the outer surface of the casing string 72 and the inner surface of the borehole 16 and allowed to set. Further, a production tubing string 84 has been positioned in an inner bore of the casing string 72.

In FIG. 1A, the well 70 corresponds to a production well and is adapted to guide a desired fluid (e.g., oil or gas) from a section of the borehole 16 to a surface of the earth 18. Perforations 82 have been formed at a section of the borehole 16 to facilitate the flow of a fluid 85 from a surrounding formation into the borehole 16 and thence to earth's surface via an opening 86 at the bottom of the production tubing string 84. Note that this well configuration is illustrative and not limiting on the scope of the disclosure. Other examples of permanent well installations include injection wells and monitoring wells.

In FIG. 1A, a cable 15 is represented as extending along an outer surface of the casing string 72. The cable 15 may take different forms and includes embedded electrical conductors and/or optical waveguides (e.g., fibers) to enable transfer of power and/or communications between sensor units 38A-38N and earth's surface. In at least some embodiments, the cable 15 is held against the outer surface of the of the casing string 72 at spaced apart locations by multiple bands 74 that extend around the casing string 72. A protective covering 78 may be installed over the cable 15 at each of the couplings 76 of the casing string 72 to prevent the cable 15 from being pinched or sheared by the coupling's contact with the borehole wall. The protective covering 78 may be held in place, for example, by two of the bands 74 installed on either side of coupling 76. In at least some embodiments, the cable 15 terminates at surface interface 14, which conveys gravitational field measurements obtained from the sensor units 38A-38N to a computer system 20.

The surface interface 14 and/or the computer system 20 may perform various operations such as converting signals from one format to another, storing the gravitational field measurements and/or processing the measurements. As an example, in at least some embodiments, the computer system 20 includes a processing unit 22 that performs the disclosed inversion operations by executing software or instructions obtained from a local or remote non-transitory computer-readable medium 28. The computer system 20 also may include input device(s) 26 (e.g., a keyboard, mouse, touchpad, etc.) and output device(s) 24 (e.g., a monitor, printer, etc.). Such input device(s) 26 and/or output device(s) 24 provide a user interface that enables an operator to interact with the logging tool 36 and/or software executed by the processing unit 22. For example, the computer system 20 may enable an operator to select inversion options, to view collected gravitational field measurements, to view inversion results, and/or to perform other tasks.

FIG. 1B shows a multi-well survey environment 10B, in which sensor units 38_AA to 38_NN to obtain gravitational field measurements are distributed in multiple boreholes 16A-16N that penetrate formations 19 of the earth 18. The sensor units 38_AA to 38_NN may be positioned in the boreholes 16A-16N as part of permanent well installations (see e.g., FIG. 1A). For each of the boreholes 16A-16N, corresponding cables 15A-15N may convey power and/or communications between the sensor units 38_AA to 38_NN and earth's surface. At earth's surface, one or more surface interfaces 14 couple to the cables 15A-15N to receive the gravitational field measurements from the sensor units 38_AA to 38_NN and to convey the gravitational field measurements to computer system 20, where inversion operations are performed as described herein.

Before proceeding it should be noted that the sensor units 38A-38N, and 38_AA to 38_NN, as well as the cables 15A-15R may vary for different embodiments. Further, it should be noted that the sensor units 38 and cables 15 may be deployed in a subsea environment rather than a downhole environment. Further, sensor units 38 and cables 15 may be deployed in a subsea well.

FIGS. 1C and 1D show subea gravitational field survey environments 10C and 10C. In the subsea survey environment 10C, a plurality of sensor units 38 are deployed along the seabed 92 of a body of water 90, where one or more cables 15 convey power and/or communications between the sensor units 38 and earth's surface. It should be appreciated that at least some of the sensors units 38 in the body of water 90 are not necessarily at the seabed 92. (Gravitational field measurements can be collected using sensor units 38 located at the seabed 92 and/or at different positions/depths in the body of water 90, etc.). At earth's surface, one or more surface interfaces 14 couple to the cables 15 to receive the gravitational field measurements from the sensor units 38 and to convey the gravitational field measurements to computer system 20, where inversion operations are performed as described herein. As an example, the inversion operations may provide density information regarding formation 19 below seabed 92. In the survey environment 10C, the surface interace 14 and computer system 20 are land-based.

For the subsea survey environment 10D, a plurality of sensor units 38 are similarly deployed along the seabed 92 of a body of water 90, where one or more cables 15 convey power and/or communications between the sensor units 38 and earth's surface. Again, it should be appreciated that at least some of the sensors units 38 in the body of water 90 are not necessarily at the seabed 92. (Gravitational field measurements can be collected using sensor units 38 at the seabed 92 and/or at different positions/depths in the body of water 90, etc.). At earth's surface, one or more surface interfaces 14 couple to the cables 15 to receive the gravitational field measurements from the sensor units 38 and to convey the gravitational field measurements to computer system 20, where inversion operations are performed as described herein. As an example, the inversion operations may provide density information regarding formation 19 below seabed 92. In the subsea survey environment 10D, the surface interace 14 and computer system 20 are located on a platform or vessel 94. For subsea survey environments such as environments 10C and 10D, the sensor units 38 and the monitoring/interrogation components would be the same or similar as for downhole scenarios, but the deployment scheme would be different. Further, the packaging of sensor units 38 may vary depending on whether the sensors units are used in downhole environment or subsea environment.

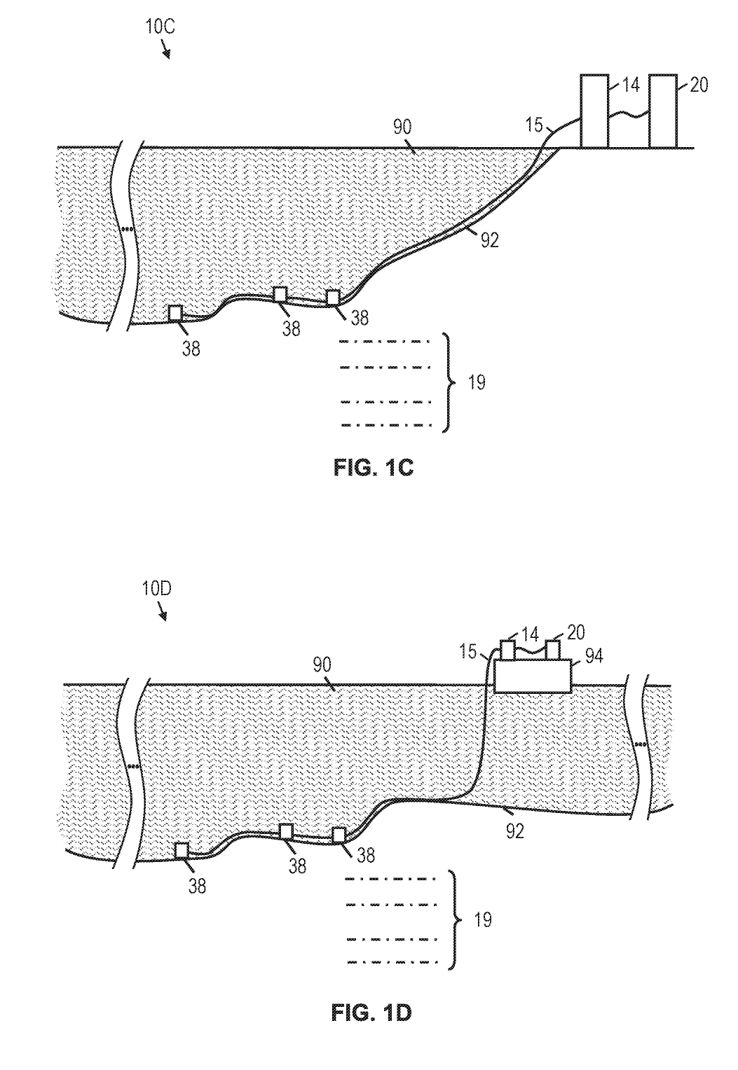

FIG. 2 shows illustrative permanent gravitational field sensor arrays 92A-92D in a downhole environment such as formation 18. Each of the permanent gravitational field sensor arrays 92A-92D may have a different number of sensor units for obtaining gravitational field measurements. As shown, the gravitational field sensor arrays 92A and 92B are distributed along casing string 72A, while gravitational field sensor arrays 92C and 92D are distributed along casing string 72B. Although not shown, one or more cables (e.g., 15) may extend along each of the casings strings 72A and 72B to enable conveyance of gravitational field measurements from sensor units 38 to earth's surface. Although not a requirement, each of the casing strings 72A and 72B is shown to extend along a two-dimensional path. More specifically, casing string 72A is shown to include a portion that is substantially aligned with the Z direction and another portion substantially aligned with the Y direction. Meanwhile, the casing string 72B is shown to include a portion that is substantially aligned with the Z direction and another portion substantially aligned with the X direction. Gravitational field sensor arrays such as arrays 92A-92D may be positioned at any point along the casing strings 72A and 72B. The decision regarding where to position gravitational field sensor arrays (e.g., arrays 92A-92D) may depend on the location of existing or planned boreholes, regions of interest within a formation (e.g., formation 18), or other criteria. Further, the spacing between the sensor units 38 for each of the permanent gravitational field sensor arrays 92A-92D may vary.

In at least some embodiments, the spacing between the sensor units 38 in a permanent gravitational field sensor array (e.g., arrays 92A-92D) may correspond to a predetermined distribution density. As an example, the predetermined distribution density may be a function of sensor sensitivity and a desired resolution of gravitational field measurements. Further, the predetermined distribution density may be a function of a predetermined gravitational gradient spacing. Further, the predetermined distribution density may be a function of a predetermined gravitational potential spacing. Further, the predetermined distribution density may be a function of a predetermined gravitational acceleration spacing. (The spacing used for measuring gravitational potential, gravitational acceleration, and gravitational gradients may vary.) Further, the predetermined distribution density may be a function of a predetermined region of interest spacing. Further, it should be understood that in a permanent gravitational field sensor array (e.g., arrays 92A-92D) the orientation of some sensor units 38 and/or their respective sensors may vary to detect gravitational field and field derivative measurements in different directions.

Before proceeding it should be noted that the sensor units 38 for FIGS. 1A, 1B, and 2 may vary for different embodiments. Further, it should be noted that the sensor units 38 and corresponding arrays may be deployed in a subsea environment rather than a downhole environment. For subsea scenarios, the sensor units 38 and the monitoring/interrogation components would still be the same or similar as for downhole scenarios, but the deployment scheme would be different. Further, the packaging of sensor units 38 may vary depending on whether sensors units are used downhole or subsea.

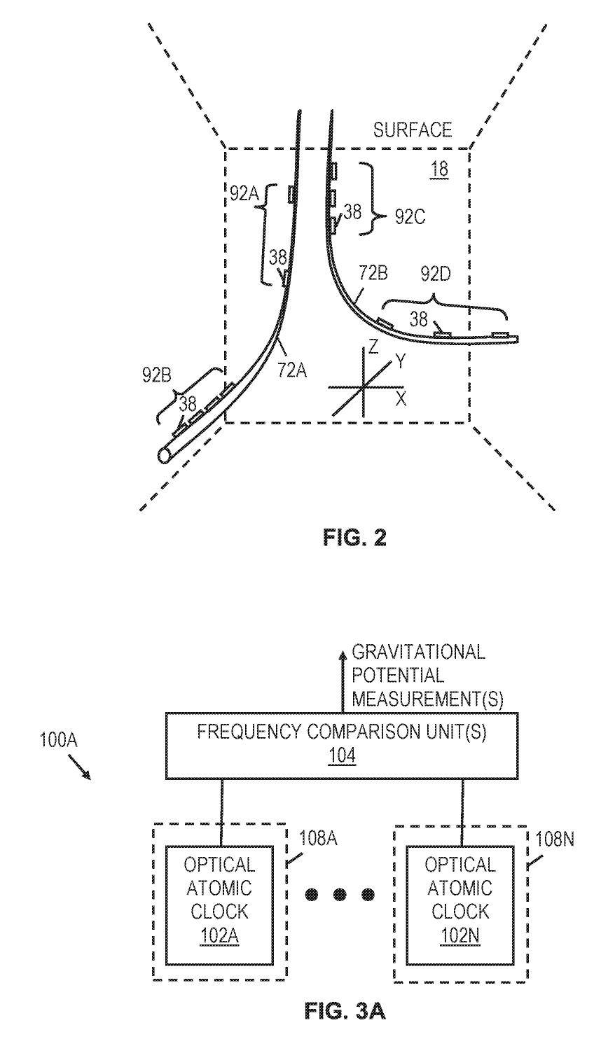

FIGS. 3A-3I show different gravitational field logging sensor configurations with various types of sensor units 108 that correspond to the sensor units 38 of FIGS. 1A, 1B, and 2. Further, the cables 15 described for FIGS. 1A and 1B may vary for different embodiments. For example, different cables 15 may support one-way communications or two-way communications. Further, different cables 15 may enable optical signal transmission and/or electrical signal transmission. To obtain gravitational field measurements, the sensor units 38 may include one or more sensors that output gravitational field measurements as electrical signals or optical signals. Further, electro-optical transducers may be employed to convert electrical signals output from the sensors as optical signals or to convert optical signals output from the sensors as electrical signals. In either case, the gravitational field measurements may be conveyed to earth's surface via one or more cables (e.g., cable 15).

One possible sensor for obtaining gravitational field measurements is an optical atomic clock. Optical atomic clocks are currently the most stable frequency sources available, vastly surpassing the traditional atomic clocks by several orders of magnitude. For example, frequency uncertainties of 8.6×10₋₁₈ have been reported in optical atomic clocks based on a single Al⁺ion. See e.g., Chou et al., Frequency Comparison of Two High-Accuracy Al⁺Optical Clocks, Physical Review Letters, Vol. 104, 070802 (2010). Other example optical atomic clocks are described in R. Le Targat et al., Experimental Realization of an Optical Second with Strontium Lattice Clocks, Nature Communications 4, Article No. 2109 (2013), and N. Hinkley et al., An Atomic Clock with 10⁻¹⁸ Instability, Science, Vol. 341, pages 1215-1218 (2013). Such clocks may be configured to produce a light beam having a carrier frequency that is locked to the clock, or alternatively a light beam that pulses at a rate that is locked to the clock.

In accordance with general relativity, gravitational field strength affects the rate at which a clock registers time. Thus, the larger the gravitational field, the slower the clock. From this effect it can be concluded that the gravitational potential, g, as a function position can be determined by comparing different clock frequencies or times, where the clocks are located at different positions.

FIG. 3A shows an illustrative gravitational field logging sensor configuration 100A for obtaining gravitational potential measurements. As shown, the configuration 100A includes a plurality of sensor units 108A-108N, each with a respective optical atomic clock 102A-102N. Each optical atomic clock may correspond to an optical clock that uses a laser to probe transitions in isolated atoms. Example optical atomic clocks have used, for example Sr or Al ion atoms to achieve increased accuracy levels compared to cesium atomic clocks. Each of the optical atomic clocks 102A-102N include, for example, quantum logic spectroscopy (QLS) components, laser cooling components, and/or other components to enable transitions of an isolated atom to be counted and used as a clock signal. At the same position, the frequency of each optical atomic clock 102A-102N is the same to within a known error threshold. However, when the optical atomic clocks 102A-102N are distributed in a downhole or subsea environment, their frequencies will be affected by gravitational field variations due to depth variation and/or proximity to materials with different densities.

Accordingly, for configuration 100A, the optical atomic clocks 102A-102N are distributed and their frequencies as a function of position are compared by frequency comparison unit(s) 104. The frequency comparison unit(s) 104 may include interferometer components, frequency comb components, frequency multiplier components, and/or other components to enable high-precision frequency comparisons, as well as a reference frequency from an atomic optical clock at the surface. In at least some embodiments, the frequency comparison unit(s) 104 is separate from the sensor units 108A-108N as shown. As an example, the frequency comparison unit(s) 104 may be part of a surface interface (e.g., surface interface 14), or a downhole or subsea interface coupled to cable 15. Alternatively, it should be appreciated that a frequency comparison unit 104 could be included with one or more of the sensor units 108A-108N.

The equation that relates height above the surface of the earth and frequency shift due to general relativistic effects is given as:

$$\frac{δ f}{{f}_{0}} = \frac{g \times Δ h}{{c}^{2}} , \qquad Equation ( 1 )$$

where δf is the shift in the clock transition frequency, f₀ is the frequency of the transition at a first position, and Δh is the difference in height between the first position and a second position (assuming that the gravitational potential only depends on the height), with c being the speed of light. In situations where the gravitational potential depends on other factors, for example, the density of formation, then the corresponding dependence should be used in the above formula. See C. W. Chou et. al, Optical Clocks and Relativity, Science, Vol. 329, pages 1630-1633 (2010). From Equation 1, a change in

$$\frac{δ f}{{f}_{0}}$$

per Gal (unit of gravity) enables evaluation of gravitational strength. For example, a change of ˜10⁻¹⁸ in the ratio in

$$\frac{δ f}{{f}_{0}}$$

is equivalent to approximately 3 μGal, which above a homogeneous earth formation is equivalent to a difference in height of approximately 1 centimeter.

The signal from the two clocks can be analyzed by interferometric methods to determine the difference in frequencies. To improve results, sources of error may be accounted for to, e.g., determine and cancel the portion of the shift that is due to gravitational field variation as a function of position. One source of error is Doppler shift due to thermal agitation. This error can be cancelled, for example, by probing optical atomic clock transitions with light from two opposite directions, which causes Doppler shifts in opposite directions that can be cancelled by combining the two measurements. Another source of error is the noise of the source laser used to probing optical atomic clock transitions. This error can be drastically mitigated by using noise feedback loop cancellation techniques. See e.g., K. Predehl et al., A 920-Kilometer Optical Fiber Link for Frequency Metrology at the 19^{th} Decimal Place, Science, Vol. 336, pages 441-444 (2012). Further, in order to achieve sufficient signal level the measurement may have to include a large number of frequency cycles. See e.g., C. W. Chou et. al, Optical Clocks and Relativity, Science, Vol. 329, pages 1630-1633 (2010), and N. Hinkley et al., An Atomic Clock with 10⁻¹⁸ Instability, Science, Vol. 341, pages 1215-1218 (2013).

In at least some embodiments, the frequency comparison unit(s) 104 combine the signals from two optical atomic clocks in an interferometer to extract the frequency shift. The output of the frequency comparison unit(s) 104 can be used to determine a gravitational potential measurement. More specifically, the frequency shift provides a measure of the difference in gravitational potential at the positions of the distributed optical atomic clocks 102A-102N. The output of the frequency comparison unit(s) 104 may be provided periodically or upon request to surface interface 14. In some embodiments, a single reference atomic optical clock at the surface can be compared with some or all downhole or subsea sensor units of a permanent gravitational field sensor array or of multiple arrays.

FIG. 3B shows another gravitational field logging sensor configuration 100B for obtaining gravitational potential measurements. The configuration 100B is similar to the configuration 100A, in that sensor units 108A-108N with respective optical atomic clocks 102A-102N are distributed in a downhole or subsea environment. However, rather than compare optical atomic clock frequencies as a function of position as in configuration 100A, the configuration 100B compares optical atomic clock time readings as a function of position. To perform the time comparisons, the configuration 100B includes time comparison unit(s) 106. For example, the time comparison unit(s) 106 may include optical-electro transducers to convert clock transitions to electrical signals that are counted, stored, and/or otherwise registered to enable a time comparison of optical atomic clocks as a function of position. In at least some embodiments, the time comparison unit(s) 106 is separate from the sensor units 108A-108N as shown. As an example, the time comparison unit(s) 106 may be part of a surface interface (e.g., surface interface 14), or a downhole or subsea interface coupled to cable 15. Alternatively, it should be appreciated that a time comparison unit 106 could be included with one or more of the sensor units 108A-108N.

The difference in the time readings between optical atomic clocks at different positions is related to the difference in gravitational potential at their respective positions. This time difference is given as:

$$Δ t = {t}_{B} - {t}_{A} = \frac{\vert {X}_{B} - {X}_{A} \vert}{c} + {( Δ t )}_{G} + {( Δ t )}_{ω} , \qquad Equation ( 2 )$$

where X_{B}, X_{A} are position coordinates of different optical atomic clocks, c is the speed of light, and (Δt)_{G}, (Δt)_{ω} is the contribution arising from the gravitational potential and earth's rotation respectively. As needed, the transmission of optical signals from the optical atomic clocks 102A-102N for time comparison operations and/or the transmission of output signals from the time comparison unit(s) 106 can be accomplished by deploying one or more fiber optic cables.

The frequency comparison technique of configuration 100A and the time comparison technique of configuration 100B have notable differences. For example, for frequency comparisons, a sufficiently long measurement time is necessary to accumulate sufficient statistics to reduce the uncertainty of the frequency difference measurement. Further, for frequency comparisons, the optical atomic clocks involved need only be active at measurement time. Meanwhile, for time comparisons, a time reading for each optical atomic sensor needs to be recorded and transmitted. Accordingly, recorded times need to be collected accurately and for a long enough period to accumulate a significant difference. Further, the time comparisons need to be repeated with sufficient frequency to be able to derive the change in gravitational potential as a function of time.

At least some embodiments, both of the configurations 100A and 100B involve transmission of electromagnetic signals between two spatially separated clocks. In both configurations 100A and 100B, optical signals generated by the optical atomic clocks 102A-102N may have a wavelength in the vicinity of 700 nm (a convenient optical clock frequency). If such optical signals are to be transmitted over several kilometers of distance, the attenuation of the optical signals in a fiber should be considered. For modern optical fibers, optical signals between 700 nm to 1800 nm have attenuation below 5 dB/km, which is viable for the intended signal transmissions in the range of a few kilometers. However, optical signals below 700 nm are less convenient because of increased attenuation in the fiber.

Regardless of the optical signal wavelength output from the optical atomic clocks 102A-102N or other components, it should be appreciated that optical frequency combs may be employed to alter the wavelength so that attenuation of signal transmission is reduced. For example, an optical frequency comb may be used in the configurations 100A or 100B to alter the wavelength of signals output from optical atomic clocks 102A-102N to around 1550 nm (telecom wavelengths). More specifically, an optical frequency comb takes an input frequency fᵢₙ and converts it to an output frequency fₒᵤₜ. The signal with frequency fᵢₙ is phase locked to the optical frequency comb, and a telecom laser is phase locked with the optical frequency comb via a frequency doubled signal such that f_{telecom}=fₒᵤₜ/2. In some embodiments, an optical frequency comb in employed for both transmitter and receiver sides. At the transmitter side, the optical frequency comb convert optical atomic clock wavelengths to telecom wavelengths. At the receiver side, the reverse operation is performed. For example, the clock laser (in the case of Strontium, 698 nm) is phase locked to the corresponding tooth of the optical frequency comb, and the telecom laser (1538 nm) is phase locked to the optical frequency comb via the frequency doubled light (769 nm). In this manner, the lasers for probing optical atomic clock transitions are indirectly phase locked to a telecom laser.

FIG. 3C shows another gravitational field logging sensor configuration 100C. In configuration 100C, two sensor units 108B and 108C are shown to include respective optical atomic clocks 102B and 102C. Further, each of the sensor units 108B and 108C includes respective frequency combs 110B, 110C and frequency multipliers 112B, 112C. In alternative embodiments, the frequency combs 110B, 110C and frequency multipliers 112B, 112C may be separate from the sensor units 108B and 108C. The frequency combs 110B, 110C are used to alter the wavelength of signals output from the optical atomic clocks 102B and 102C to enable transmission of optical signals over longer distances as described herein. For example, an optical signal output related to sensor unit 108B may be transmitted to sensor unit 108C via optical fiber 114, which extends between the positions (e.g., Δh) of sensor units 108B and 108C. The dependence of the gravitational potential on Δh is just an example, and other dependence is possible. If Δh=0, then the comparison of the gravitational potential between 108B and 108C will provide information about, for example, the formation density.

Another type of sensor that could be used to obtain gravitational field measurements is a pendulum gravity sensor. One type of pendulum gravity sensor uses a laser beam to monitor the position of the pendulum (e.g., period and/or maximum amplitude). The pendulum period and maximum angular amplitude are related to the local value of gravity as follows:

$$T = 4 \sqrt{L / g} K [ Sin ( \frac{{θ}_{0}}{2} ) ] , \qquad Equation ( 3 )$$

where T is the period of the movement, L is the length, g the local value of gravity, θ₀ is the maximum oscillation amplitude of the pendulum, and K is the complete elliptic integral of the first kind.

FIG. 3D shows a gravitational field logging sensor configuration 100D, which employs an optically-monitored pendulum gravity sensor 130. As shown, configuration 100D includes a sensor unit 108D with the optically-monitored pendulum gravity sensor 130. The sensor 130 includes various components in a vacuum. More specifically, the sensor 130 includes a pendulum 132 within a resonant optical cavity 136 defined by the position of metal plates 134 (e.g., blue plates), where movement of the pendulum changes to the size of the resonant optical cavity 136 resulting in resonant frequency shifts. The impinging light will transfer some momentum to the pendulum 132, but this effect can be cancelled by passing light beams in opposite directions. With both beams providing complementary measurements that can improve the accuracy of the measurement.

For the configuration 100D, the metal plates 134 may have an optical coating 138 (e.g., a yellow coating) on the side that faces the pendulum 132. Likewise, the pendulum 132 may have an optical coating (not shown). Further, the optically-monitored pendulum gravity sensor 130 may include a reference mirror 137. In operation, a light beam 120 having a wide spectrum 122 is input to the sensor 130. The output of the sensor 130 corresponds to a light beam 140 having a shifted wavelength 142 relative to the resonant frequency of the optical resonant cavity 136. The shifted wavelength 142 can be correlated to movement of the pendulum, which is affected by the local gravitational field strength. The light beam 140 is conveyed to earth's surface, for example, via one or more optical fibers whereby gravitation field measurements as a function of position are collected.

Another type of pendulum gravity sensor uses electrical capacitance measurements to monitor a pendulum's period and maximum amplitude. See e.g., Equation 3 and U.S. Pat. App. Pub. No. 20080295594. In an example configuration, the pendulum may be in the form of a plate that oscillates between two other plates. The movement of the pendulum plate changes the coupling capacitance between the pendulum and the other plates, which is measured precisely. This type of pendulum sensor can be deployed with or without an electro-optical transducer to obtain gravitational field measurements (see e.g., FIGS. 3E and 3F).

FIG. 3E shows a gravitational field logging sensor configuration 100E, which employs a pendulum gravity sensor 150 using electrical capacitance measurements to monitor a pendulum's period and maximum amplitude. In configuration 100E, the pendulum gravity sensor 150 resides in sensor unit 108E. The output from the sensor unit 108E corresponds to a gravitational acceleration measurement that can be conveyed to earth's surface via an electrical conductor.

FIG. 3F shows a gravitational field logging sensor configuration 100F, which employs a pendulum gravity sensor 150 similar to the configuration 100E of FIG. 3E. In configuration 100F, the pendulum gravity sensor 150 as well as an electro-optical transducer 154 reside in sensor unit 108F. The output 152 of the pendulum gravity sensor 150 is provided to electro-optical transducer 154 for conversion to an optical signal. The output from the sensor unit 108F corresponds to a gravitational acceleration measurement that can be conveyed to earth's surface via an optical fiber.

FIG. 3G shows a gravitational field logging sensor configuration 100G, which employs a rotating gravity gradiometer 160. In configuration 100G, the rotating gravity gradiometer 160 resides in sensor unit 108G. The rotating gravity gradiometer 160 may correspond to a known type of gradiometer sensor (see e.g., U.S. Pat. No. 5,357,802). The output from the sensor unit 108G corresponds to a gravitational gradient measurement that can be conveyed to earth's surface via an electrical conductor.

FIG. 3H shows a gravitational field logging sensor configuration 100H, which employs a rotating gravity gradiometer 160. In configuration 100H, the rotating gravity gradiometer 160 as well as an electro-optical transducer 164 reside in sensor unit 108H. The output 162 of the rotating gravity gradiometer 160 is provided to electro-optical transducer 164 for conversion to an optical signal. The output from the sensor unit 108H corresponds to a gravitational gradient measurement that can be conveyed to earth's surface via an optical fiber.

FIG. 3I shows a gravitational field logging sensor configuration 1001, which employs sensor units 108G or 108H (each with a rotating gravity gradiometer 160) in different orientations. More specifically, part (A) of FIG. 3I shows a first sensor unit 108G or 108H (and corresponding rotating gravity gradiometer 160) aligned with a Y-Z plane. Meanwhile, part (B) of FIG. 3I shows a second sensor unit 108G or 108H (and corresponding rotating gravity gradiometer 160) aligned with an X-Y plane. Finally, part (C) of FIG. 3I shows a third sensor unit 108G or 108H (and corresponding rotating gravity gradiometer 160) aligned with an X-Z plane. By orienting different sensor units 108G or 108H along different (orthogonal) planes, a complete set of gravitational gradient measurements as a function of position is possible. Even if the planes are not orthogonal, a complete set of gravitational gradient measurements can be generated as long as the planes are not linearly dependent of each other. It should be noted that the packaging for the various sensor units of configurations 100A-100I described herein may vary depending on the type of gravity sensor used and the inclusion of other components.

In at least some embodiments, the sensor units 38 described herein are coupled to a fiber optic interrogation system. Alternatively, the sensor units 38 described herein are coupled to an electrical interrogation system. In an example fiber optic system, an interrogation light pulse is sent from the surface to a sensor via an optical fiber. When the pulse reaches the sensor, the light pulse is modified by the sensor, where the modified light pulse encodes measurement information. The modified light pulse is conveyed to earth's surface using the same or different optical fiber, and the measurement information is thereafter processed. An electrical interrogation system may similarly send an electrical pulse that is modified by the sensor to encode measurement information.

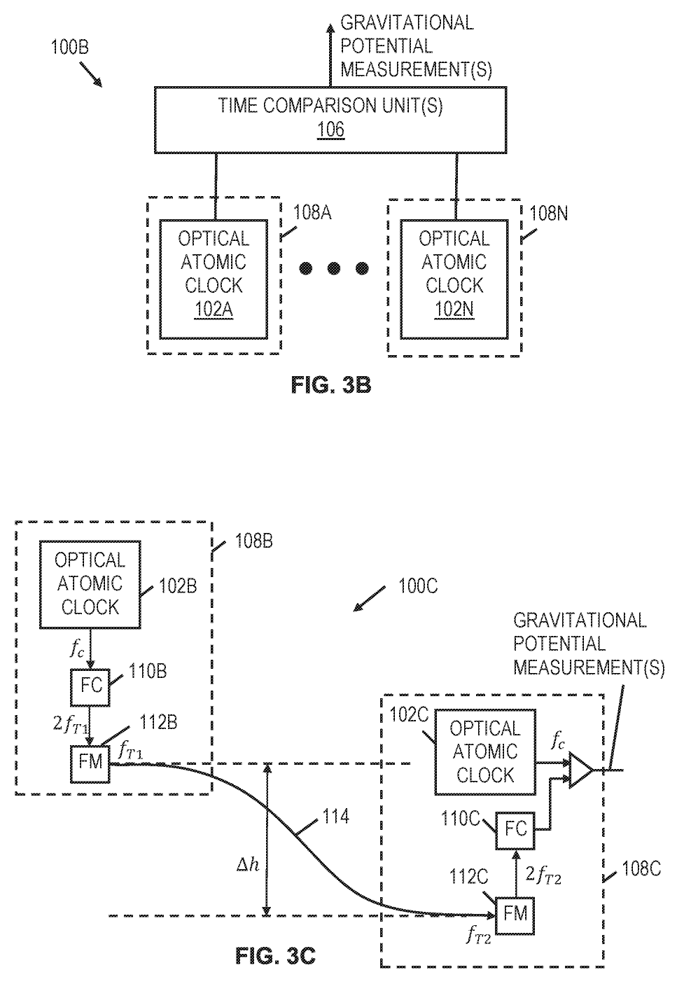

In different interrogation system embodiments, many downhole or subsea sensor units can be connected to a single optical fiber or electrical conductor. Further, frequency-division multiplexing (FDM), time-division multiplexing (TMD), and/or mode-division multiplexing (MDM) may be employed to enable multiple sensors located at different positions to provide a measurement with a single optical or electrical pulse sent from the surface. FIG. 4 shows an example optical frequency multiplexing process. As shown, a broadband light 200 is input to a first sensor unit 38A. The output 202 of the sensor units 38A includes a pulse (λ₁) corresponding to a gravitational field measurement and a portion of the broadband light 200. Sensor units 38B-38D likewise use a portion of the original broadband signal 200 to provide gravitational field measurements (see λ₂ in output 204, λ₃ in output 206, and λ₄ in output 208). The output 208 include pulses λ₁-λ₄, which respectively encode gravitational field measurements from sensor units 38A-38D. The pulses λ₁-λ₄ are conveyed back to earth's surface. At earth's surface, the pulses λ₁-λ₄ are processed to recover the encoded gravitational field measurements from each of the sensor units 38A-38D. The sensor units 38A-38D may correspond to the sensor units 208A-208N

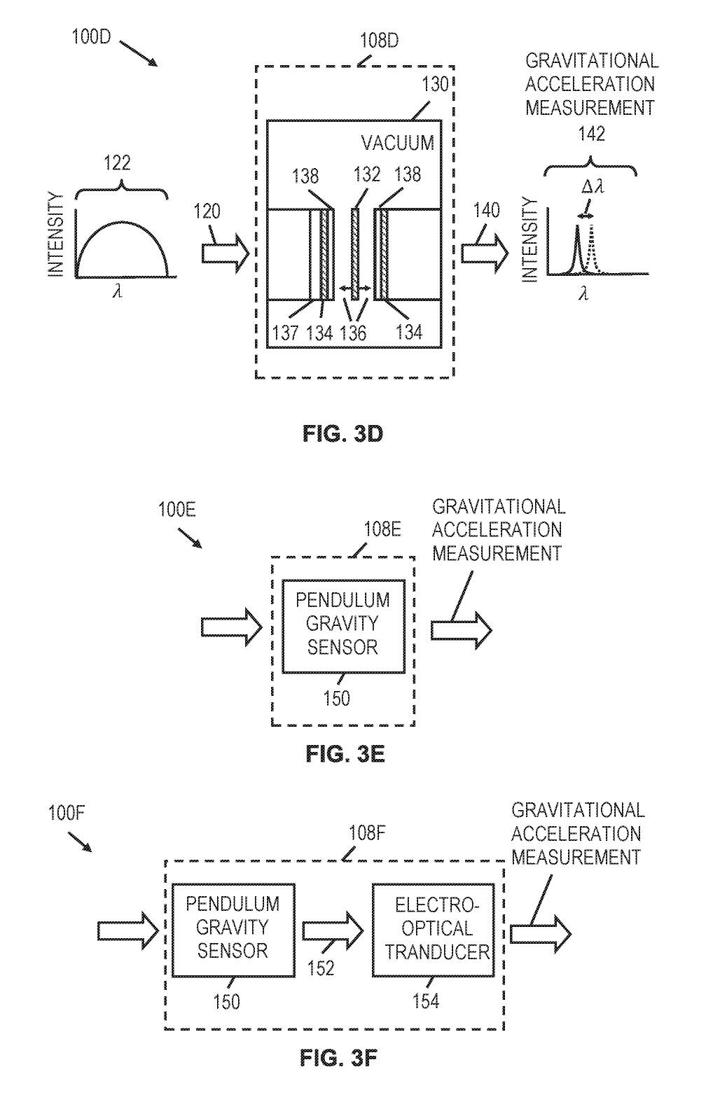

FIG. 5 shows an example optical array of sensor units 38A-38N with a unidirectional configuration 210. In configuration 210, sensor units 38A-38N are positioned along a fiber optic system that includes unidirectional couplers 220 and amplifier portions (e.g., Erbium-doped fiber portions) 222. In response to the input light 212 or portions thereof, the sensor units 38A-38N output optical signals with encoded gravitational field measurements. The output light 214 corresponds to a TDM or FDM return signal with the encoded gravitational field measurements.

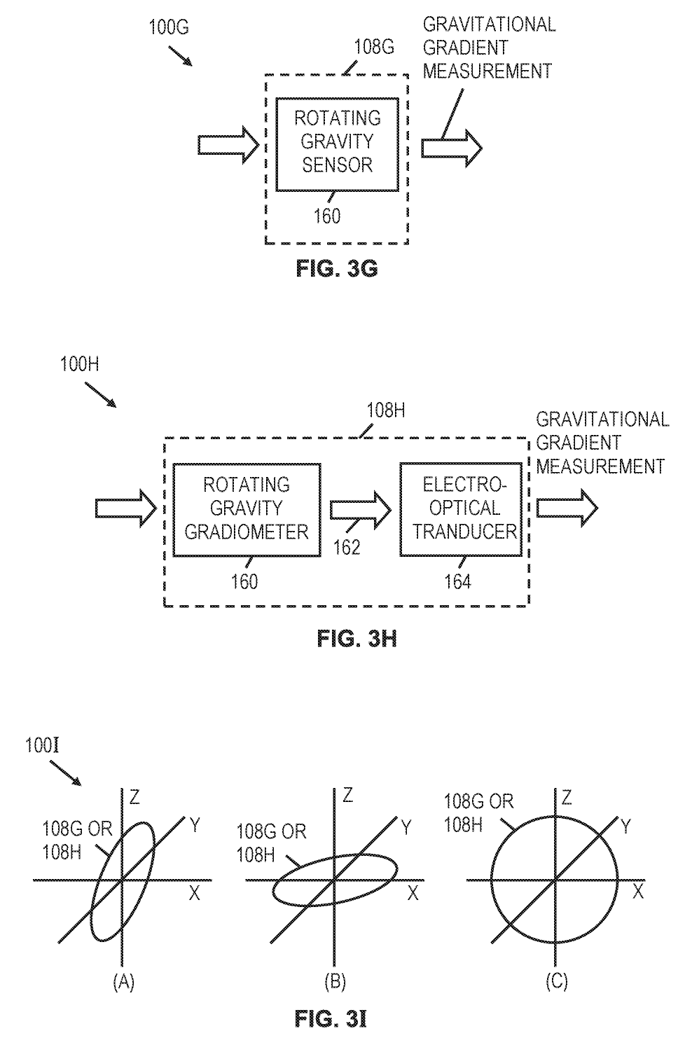

FIG. 6 shows an optical array of sensor units with a bidirectional configuration 216. In configuration 216, sensor units 38A-38N are positioned along a fiber optic system that includes bidirectional couplers 220 and amplifier portions (e.g., Erbium-doped fiber portions) 222. In response to input light 212A or portions thereof, the sensor units 38A-38N output optical signals with encoded gravitational field measurements. The output light 214A corresponds to a TDM and/or FDM return signal with the encoded gravitational field measurements in response to input light 212A. Similarly, in response to input light 212B or portions thereof, the sensor units 38A-38N output optical signals with encoded gravitational field measurements. The output light 214B corresponds to a TDM and/or FDM return signal with the encoded gravitational field measurements in response to input light 212B. As needed, time delays may be used in configurations 210 and 216 between the optical branches to avoid mixing data from different branches.

For energy efficiency, sensor units 38 can be activated and measurements can be taken periodically. This allows monitoring applications (such as water-flood monitoring or other fluid movement monitoring), as well as applications where only small number of measurements are required (fracturing). For further efficiency, a different set of sensor units 38 may be activated in different periods. The measurements collected by the sensor units 38 can be correlated with open-hole logs in the same well, if available, for calibration purposes. Ratios or differences of signals from different sensor units 38 can be taken for removing unwanted effects or increasing the sensitivity of the measurement to desired quantities. For example, sensor units 38 that are sufficiently close together may enable error cancellation schemes that improve accuracy of a gravitational field measurement for a given position related to the closely spaced sensor units 38.

In at least some embodiments, frequency dependent characteristics of the sensor transfer function can be subtracted out by characterizing the frequency dependent characteristics and providing compensation. Through the use of multiple downhole or subsea sensor unit positions, orientations and/or multiple frequencies, a parameterized model of the formation can be inverted. As an example, the disclosed sensing system can be used for monitoring entire fields. Further, with steam-assisted gravity drilling (SAGD) applications, the wells can be drilled at an optimized distance with respect to each other to cover a volume of interest from multiple sides and the data provided by the sensors can be used in an optimal inversion of formation density. Further, in at least some embodiments, at least some of the sensor units 38 correspond to subsea units. For example, such subsea units may be distributed at a number of positions of a sea bed.

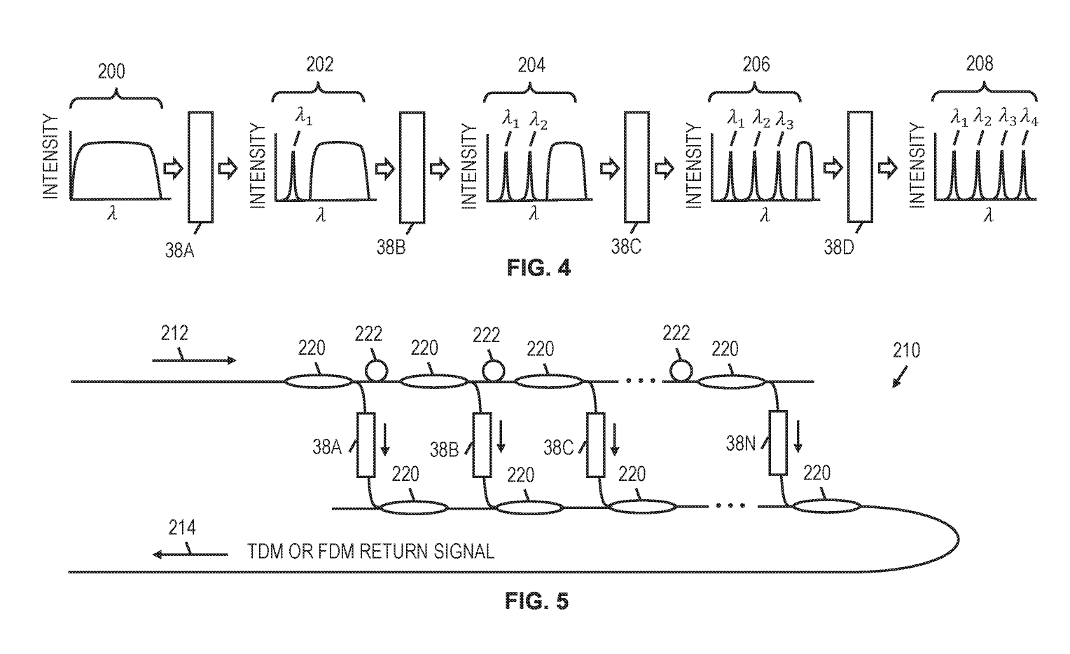

FIG. 7 shows a flowchart of an illustrative gravitational logging control process 300. The process 300 may be performed, for example, by a computer (e.g., computer system 20) in communication with one or more of the downhole or subsea sensor units 38 described herein. As shown, the process 300 includes obtaining gravitational sensor measurements and positions at block 302. At block 304, the gravitational sensor measurements and positions are processed (e.g., inverted) to obtain a formation density as a function of position. At block 306, the inversion results are evaluated. For example, an average standard deviation (STD) evaluation may be performed at block 306. If the STD is less than a threshold (decision block 308), the process 300 ends at block 310. Otherwise, the process 300 returns to block 302, where more sensor measurements/positions are obtained. The blocks 302, 304, 306 and 308 of process 300 are repeated as needed until the STD is less than a threshold.

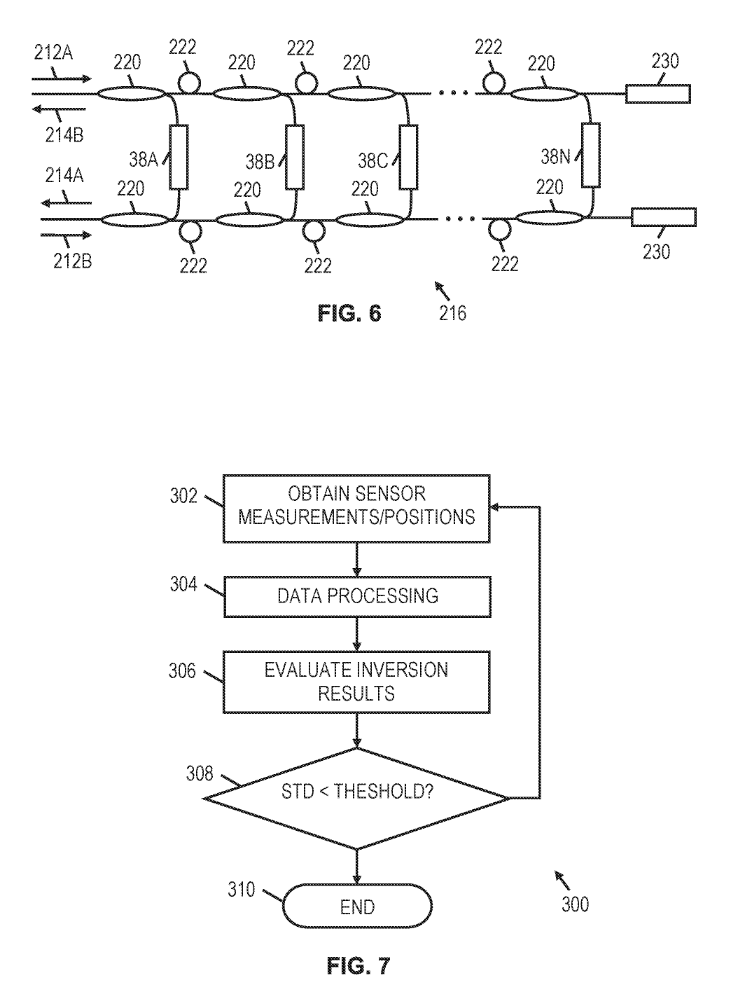

FIG. 8 shows a flowchart of an illustrative gravitational log inversion process 400. The process 400 may be performed, for example, by a computer (e.g., computer system 20) in communication with one or more of the downhole or subsea sensor units described herein. As shown, the process 400 includes performing forward modeling 404 using an initial formation density model 402. The forward modeling block 404 uses the density distribution provided by the initial formation density model 402 to predict gravitational fields representative of that density distribution. As an example, the forward modeling block 404 could use Newton's inverse squared law or an iterative process to approximate the representative gravitational fields.

Further, gravitational sensor measurements and positions are obtained at block 406. At decision block 410, the gravitational field measurements as a function of position obtained at block 406 are compared with the gravitational fields predicted by the forward modeling block 404. If the difference between the gravitational field measurements and predicted gravitational fields are less than a threshold (decision block 410), the current formation density model is accepted. Otherwise, the formation density model is adjusted and the adjusted model is input to the forward modeling block 404. As needed, the process 400 repeats the steps of blocks 404, 406, 410, and 412 until the difference between the gravitational field measurements and the predicted gravitational fields are less than a threshold. In at least some embodiments, the process 400 can also be used to determination of a gravitational field rate of change in a reservoir. This rate of change information could be used by a gravitational logging control system to increase or decrease the frequency of obtaining gravitational field measurements.

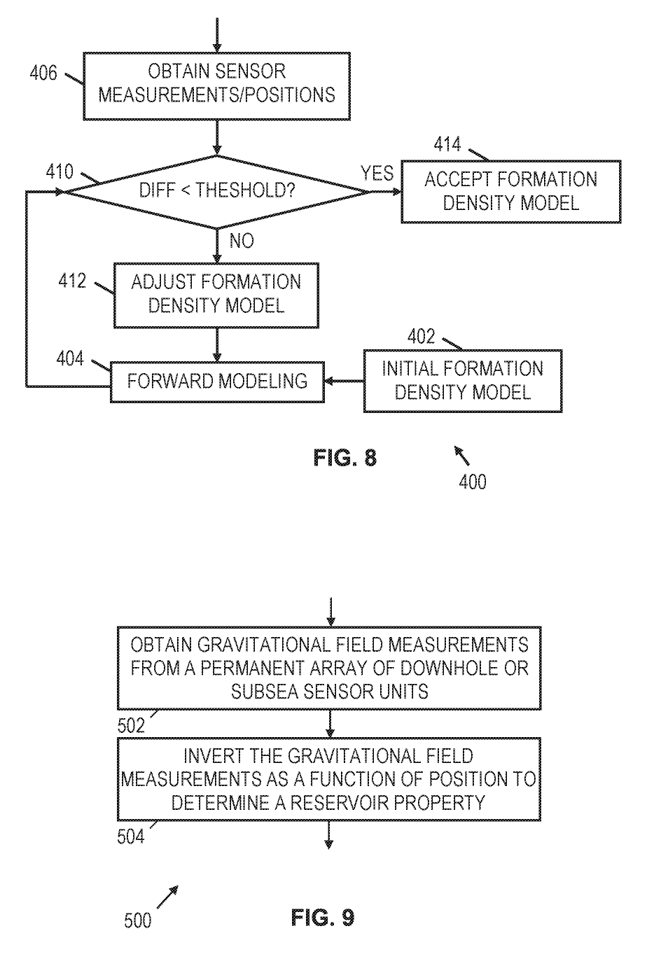

FIG. 9 shows a flowchart of an illustrative gravitational logging method 504. The method 504 may be performed, for example, by a computer (e.g., computer system 20) in communication with one or more of the downhole or subsea sensor units 38 described herein. At block 502, gravitational field measurements are obtained from a permanent array of sensor units. For example, the gravitational field measurements may be obtained using any of the survey environments 10A and 10B of FIGS. 1A and 1B, subsea environments, and any of the gravitational field logging sensor configurations 100A-100I of FIGS. 3A-3I. Further, the gravitational field measurements may be obtained from sensor units 38 spaced according to a predetermined distribution density as described herein. At block 504, the gravitational field measurements are inverted as a function of position to determine a formation property. For example, block 504 may performed in accordance with processes 300 and 400 of FIGS. 7 and 8.

Embodiments disclosed herein include:

A: A gravitational logging method that comprises obtaining gravitational field measurements from a permanent array of downhole or subsea sensor units, and inverting the gravitational field measurements as a function of position to determine a reservoir property.

B: A gravitational logging system that comprises a permanent array of downhole or subsea sensor units to obtain gravitational field measurements, and a processing unit that inverts the gravitational field measurements as a function of position to determine a formation property.

Each of the embodiments, A and B, may have one or more of the following additional elements in any combination. Element 1: further comprising positioning at least some of the permanent array of sensor units based on a predetermined distribution density. Element 2: the predetermined distribution density is a function of a predetermined gravitational gradient spacing. Element 3: the predetermined distribution density is a function of a predetermined gravitational potential spacing. Element 4: the predetermined distribution density is a function of a predetermined region of interest spacing. Element 5: further comprising positioning at least some of the permanent array of sensor units across multiple boreholes. Element 6: further comprising positioning at least some of the permanent array of sensor units during permanent well installation operations. Element 7: inverting the gravitational field measurements to determine a reservoir property comprises inverting at least one of a gravitational potential, a gravitational acceleration, and a gravitational gradient to determine density as a function of position. Element 8: further comprising repeating the steps of obtaining gravitational field measurements and inverting the gravitational field measurements periodically to monitor reservoir fluid movement. Element 9: further comprising outputting, by one of the sensor units of the permanent array, an electrical signal corresponding to a gravitational field measurement. Element 10: further comprising outputting, by one of the sensor units of the permanent array, an optical signal corresponding to a gravitational field measurement. Element 11: further comprising obtaining, by one of the sensor units of the permanent array, a gravitational field measurement as an electrical signal and converting the electrical signal to an optical signal. Element 12: further comprising performing, by one of the sensor units of the permanent array, a timing or frequency comparison of different optical atomic clocks.

Element 13: the permanent array of sensor units comprise pendulum gravity sensors. Element 14: movement of at least one of the pendulum gravity sensors is monitored using a light beam. Element 15: the permanent array of sensor units comprise rotating gravity gradiometers. Element 16: the permanent array of sensor units comprise different optical atomic clocks. Element 17: further comprising a frequency comparison unit to compare frequencies of the different optical atomic clocks, wherein the processing unit uses an output s of the frequency comparison unit invert the gravitational field measurements. Element 18:

further comprising a time comparison unit to compare time values of the different optical atomic clocks, wherein the processing unit uses an output of the time comparison unit to invert the gravitational field measurements. Element 19: the permanent array of sensor units is distributed along a borehole or subsea terrain with spacing based at least in part on a predetermined distribution density. Element 20: the permanent array of sensor units is distributed along multiple boreholes with spacing based at least in part on a predetermined distribution density.

Numerous other variations and modifications will become apparent to those skilled in the art once the above disclosure is fully appreciated. It is intended that the following claims be interpreted to embrace all such variations and modifications where applicable.

1. A gravitational logging method, comprising:
obtaining gravitational field measurements from a permanent array of downhole or subsea sensor units; and
inverting the gravitational field measurements as a function of position to determine a reservoir property.

2. The method of claim 1, further comprising positioning at least some of the permanent array of sensor units based on a predetermined distribution density.

3. The method of claim 2, wherein the predetermined distribution density is a function of a predetermined gravitational gradient spacing.

4. The method of claim 2, wherein the predetermined distribution density is a function of a predetermined gravitational potential spacing.

5. The method of claim 1, wherein the predetermined distribution density is a function of a predetermined region of interest spacing.

6. The method of claim 1, further comprising positioning at least some of the permanent array of sensor units across multiple boreholes.

7. The method of claim 1, further comprising positioning at least some of the permanent array of sensor units during permanent well installation operations.

8. The method of claim 1, wherein inverting the gravitational field measurements to determine a reservoir property comprises inverting at least one of a gravitational potential, a gravitational acceleration, and a gravitational gradient to determine density as a function of position.

9. The method of claim 1, further comprising repeating said obtaining and said inverting periodically to monitor reservoir fluid movement.

10. The method of claim 1 , further comprising outputting, by one of the sensor units of the permanent array, an electrical signal corresponding to a gravitational field measurement.

11. The method of claim 1, further comprising outputting, by one of the sensor units of the permanent array, an optical signal corresponding to a gravitational field measurement.

12. The method of claim 1, further comprising obtaining, by one of the sensor units of the permanent array, a gravitational field measurement as an electrical signal and converting the electrical signal to an optical signal.

13. The method claim 1, further comprising performing, by one of the sensor units of the permanent array, a timing or frequency comparison of different optical atomic clocks.

14. A gravitational logging system, comprising:
a permanent array of downhole or subsea sensor units to obtain gravitational field measurements; and
a processing unit that inverts the gravitational field measurements as a function of position to determine a reservoir property.

15. The gravitational logging system of claim 14, wherein the permanent array of sensor units comprise pendulum gravity sensors.

16. The gravitational logging system of claim 14, wherein movement of at least one of the pendulum gravity sensors is monitored using a light beam.

17. The gravitational logging system of claim 14, wherein the permanent array of sensor units comprise rotating gravity gradiometers.

18. The gravitational logging system of claim 14, wherein the permanent array of sensor units comprise different optical atomic clocks.

19. The gravitational logging system of claim 18, further comprising a frequency comparison unit to compare frequencies of the different optical atomic clocks, wherein the processing unit uses an output of the frequency comparison unit invert the gravitational field measurements.

20. The gravitational logging system of claim 18, further comprising a time comparison unit to compare time values of the different optical atomic clocks, wherein the processing unit uses an output of the time comparison unit to invert the gravitational field measurements.

21. The gravitational logging system of claim 14, wherein the permanent array of sensor units is distributed along a borehole or subsea terrain with spacing based at least in part on a predetermined distribution density.

22. The gravitational logging system of claim 14, wherein the permanent array of sensor units is distributed along multiple boreholes with spacing based at least in part on a predetermined distribution density.
